(19) United States
(12) Patent Application Publication
(10) Pub. No.: US 2014/0195598 A1
(43) Pub. Date: Jul. 10, 2014

(54) SYSTEM AND METHOD FOR COMPUTER PERIPHERAL ACCESS FROM CLOUD COMPUTING DEVICES

(71) Applicant: NVIDIA Corporation, Santa Clara, CA (US)

(72) Inventors: Victor PRUPIS, Palo Alto, CA (US); Andrija BOSNJAKOVIC, Santa Clara, CA (US); Aleksandar ODOROVIC, Santa Clara, CA (US); Vitaliy PUGACH, Sunnyvale, CA (US); Alok AHUJA, Santa Clara, CA (US)

(73) Assignee: NVIDIA Corporation, Santa Clara, CA (US)

(21) Appl. No.: 14/137,980

(22) Filed: Dec. 20, 2013

Related U.S. Application Data
(60) Provisional application No. 61/749,231, filed on Jan. 4, 2013.
(60) Provisional application No. 61/749,224, filed on Jan. 4, 2013.
(60) Provisional application No. 61/749,233, filed on Jan. 4, 2013.

(51) Int. Cl. H04L 29/06

(52) U.S. Cl. CPC H04L 67/42
USPC 709/203

(57) ABSTRACT

A method includes monitoring data communicated over a bus and determining that the data is communicated between a peripheral device and a client device. The method also includes sending the data in an unaltered form, and an identifier identifying the peripheral device, to a cloud server, wherein the data is operable to be received by a device driver executing on the cloud server. Another method includes receiving data in an unaltered form and an identifier identifying a peripheral device, wherein the unaltered data is a forwarded communication between the peripheral device and a client device. The method also includes enabling a device driver based on the received identifier. The method also includes executing one or more commands via the device driver, based on the received data.

### CROSS-REFERENCE TO RELATED APPLICATIONS

This application claims priority from U.S. Provisional Application No. 61/749,231, “HANDHELD GAMING CONSOLE,” Attorney Docket NVID P-SC-12-0470-US0, filed Jan. 4, 2013, the entire disclosure of which is incorporated herein by reference. This application claims priority from U.S. Provisional Application No. 61/749,224, “NETWORK-ATTACHED GPU DEVICE,” Attorney Docket NVID P-SC-12-0814-US0, filed Jan. 4, 2013, the entire disclosure of which is incorporated herein by reference. This application claims priority from U.S. Provisional Application No. 61/749,233, “STREAMING FOR PORTABLE GAMING DEVICE,” Attorney Docket NVID P-SC-12-0862-US0, filed Jan. 4, 2013, the entire disclosure of which is incorporated herein by reference.

### BACKGROUND OF THE INVENTION

Cloud-computing technologies offer intuitive methods for leveraging resources and improving performance. Cloud-computing has become popular in both gaming and workstation environments. Historically, an application such as a video game or productivity application was executed using a personal computer (PC) or using a console attached to a television. A user may have purchased an application or game, which was loaded onto the PC or inserted into the game console and then executed in a well-known manner

More recently, application and gaming resources have moved to the “cloud.” A client device may connect to a server within the cloud having the resources necessary for executing the application or game. The client device simply acts as a terminal for a user to access the resources on the server and in turn execute the application or game.

However, cloud-computing technologies also create certain challenges. One such challenge is access to various peripheral devices that may be physically located on a device other than the device actually requiring functionality of the peripheral device. For example, a peripheral device may be connected to a client device that accesses a server within a cloud. The server may provide a virtual desktop for the client device, however the server device may have no knowledge about or access to the peripheral device connected to the client device.

Existing solutions that transfer functionality of well-known and tightly defined peripheral devices over special purpose protocols. After a network transfer of data, the peripheral devices are “recreated” on the remote machine. However, these solutions only work with peripheral devices that are known about ahead of time and for which device drivers already exist on the remote machine.

Accordingly, a need exists to remedy these shortcomings

### BRIEF SUMMARY OF THE INVENTION

In some embodiments, an apparatus includes a monitoring module operable to monitor data communicated over a bus. The apparatus further includes a detection module operable to determine that the data is communicated between a peripheral device and a client device. The apparatus additionally includes a forwarding module operable to send the data in an unaltered form, and an identifier identifying the peripheral device, to a cloud server, wherein the data is operable to be received by a device driver executing on the cloud server.

In some embodiments, the apparatus further includes an encryption module operable to encrypt the data prior to the sending by the forwarding module. In some embodiments, the peripheral device and the client device are within a cloud-computing environment. In some embodiments, the bus is a universal serial bus (USB). In some embodiments, the peripheral device is an input device.

In some embodiments, a method includes monitoring data communicated over a bus. The method further includes determining that the data is communicated between a peripheral device and a client device. The method additionally includes sending the data in an unaltered form, and an identifier identifying the peripheral device, to a cloud server, wherein the data is operable to be received by a device driver executing on the cloud server.

In some embodiments, the method also includes encrypting the data prior to the sending.

In some embodiments, the peripheral device and the client device are within a cloud-computing environment. In some embodiments, the bus is a universal serial bus (USB). In some embodiments, the peripheral device is an input device.

In some embodiments, an apparatus includes a receiving module operable to receive data in an unaltered form and an identifier identifying a peripheral device, wherein the unaltered data is a forwarded communication between the peripheral device and a client device. The apparatus further includes an enabling module operable to enable a device driver based on the received identifier. The apparatus additionally includes an execution module operable to execute one or more commands via the device driver, based on the received data.

In some embodiments, the apparatus further includes a decryption module operable to decrypt the data prior to the receiving by the receiving module. In some embodiments, the apparatus further includes a forwarding module operable to send audio and video data associated with the executed commands to the client device. In some embodiments, the peripheral device is an input device. In some embodiments, the peripheral device and the client device are within a cloud-computing environment.

In some embodiments, a method includes receiving data in an unaltered form and an identifier identifying a peripheral device, wherein the unaltered data is a forwarded communication between the peripheral device and a client device. In some embodiments, the method further includes enabling a device driver based on the received identifier. In some embodiments, the method additionally includes executing one or more commands via the device driver, based on the received data.

In some embodiments, the method further includes decrypting the data prior to the receiving. In some embodiments, the method further includes sending audio and video data associated with the executed commands to the client device. In some embodiments, the peripheral device is an input device. In some embodiments, the peripheral device and the client device are within a cloud-computing environment.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram of an example of a computer system capable of implementing embodiments according to the present invention.

FIG. 2 is a block diagram of an example of a client device capable of implementing embodiments according to the present invention.

FIG. 3 is a block diagram of an example of a network architecture in which client systems and servers may be coupled to a network, according to embodiments of the present invention.

FIG. 4 is a block diagram of a computer peripheral access system, according to embodiments of the present invention.

FIG. 5A is a block diagram of a client device, according to embodiments of the present invention.

FIG. 5B is a block diagram of a server, according to embodiments of the present invention.

FIG. 6 is a block diagram of a handheld gaming console communicatively coupled with a cloud-based server, according to embodiments of the present invention

FIG. 7 depicts a flowchart of an exemplary computer-implemented process of accessing a computer peripheral device, according to an embodiment of the present invention.

FIG. 8 depicts a flowchart of an exemplary computer-implemented process of sending unaltered data between a client device and peripheral device to a cloud-based server.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

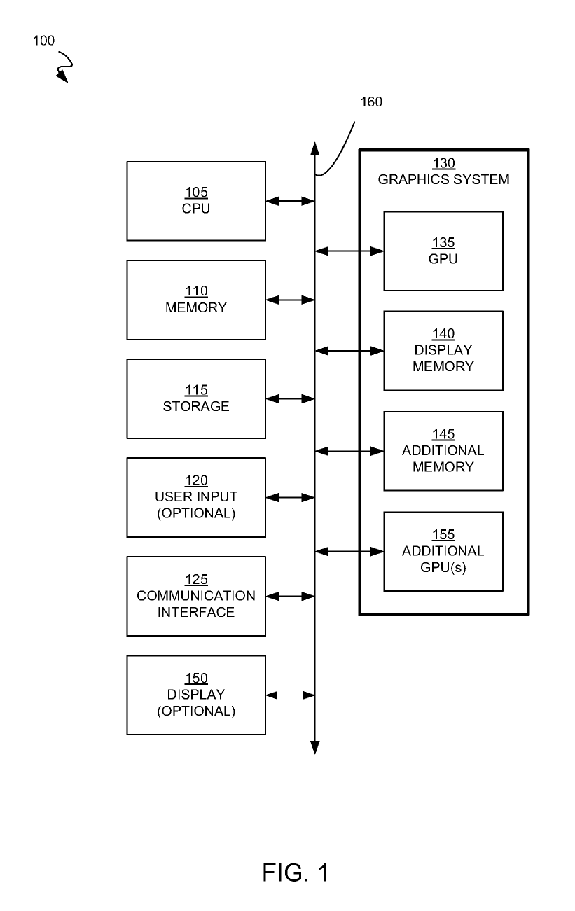

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “generating,” “sending,” “decoding,” “encoding,” “accessing,” “streaming,” or the like, refer to actions and processes of a computer system or similar electronic computing device or processor (e.g., system 100 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computer system 100 capable of implementing embodiments according to the present invention. In the example of FIG. 1, the computer system 100 includes a central processing unit (CPU) 105 for running an operating system, wherein the operating system may run software applications. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the Internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more system buses 160. System buses 160 may be or may include data buses, control buses, address buses, and/or any other internal buses.

In the embodiment of FIG. 1, a graphics system 130 may be coupled with the system bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a framebuffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the system bus 160, or each additional GPU 155 can be located on another circuit board separately coupled with the system bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

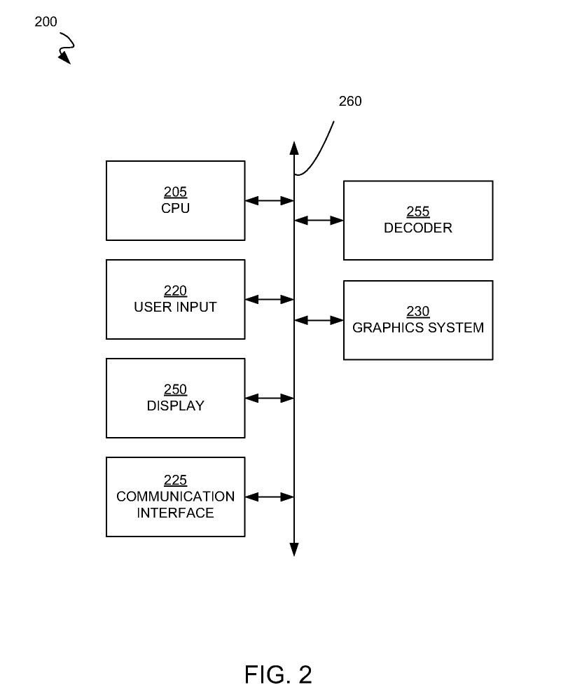

FIG. 2 is a block diagram of an example of an end user or client device 200 capable of implementing embodiments according to the present invention. In the example of FIG. 2, the client device 200 includes a CPU 205 for running an operating system, wherein the operating system may run software applications. The user input 220 includes devices that communicate user inputs from one or more users and may include keyboards, mice, joysticks, touch screens, and/or microphones.

The communication interface 225 allows the client device 200 to communicate with other computer systems (e.g., the computer system 100 of FIG. 1) via an electronic communications network, including wired and/or wireless communication and including the Internet. The decoder 255 may be any device capable of decoding (decompressing) video data that may be encoded (compressed). For example, the decoder 255 may be an H.264 decoder. The display device 250 may be any device capable of displaying visual information, including information received from the decoder 255. The display device 250 may be used to display visual information generated at least in part by the client device 200. However, the display device 250 may be used to display visual information received from the computer system 100. The components of the client device 200 may be coupled via one or more data buses 260. Further, the components may or may not be physically included inside the housing of the client device 200. For example, the display 250 may be a monitor that the client device 200 communicates with either through cable or wirelessly.

Relative to the computer system 100, the client device 200 in the example of FIG. 2 may have fewer components and less functionality and, as such, may be referred to as a thin client. However, the client device 200 may include other components including all those described above with regard to the computer system 100, for example, graphics system 230 that may be similar to graphics system 130 of FIG. 1. In general, the client device 200 may be any type of device that has display capability, the capability to decode (decompress) data, and the capability to receive inputs from a user and send such inputs to the computer system 100. However, the client device 200 may have additional capabilities beyond those just mentioned. The client device 200 may be, for example, a personal computer, a tablet computer, a television, a hand-held gaming system, or the like.

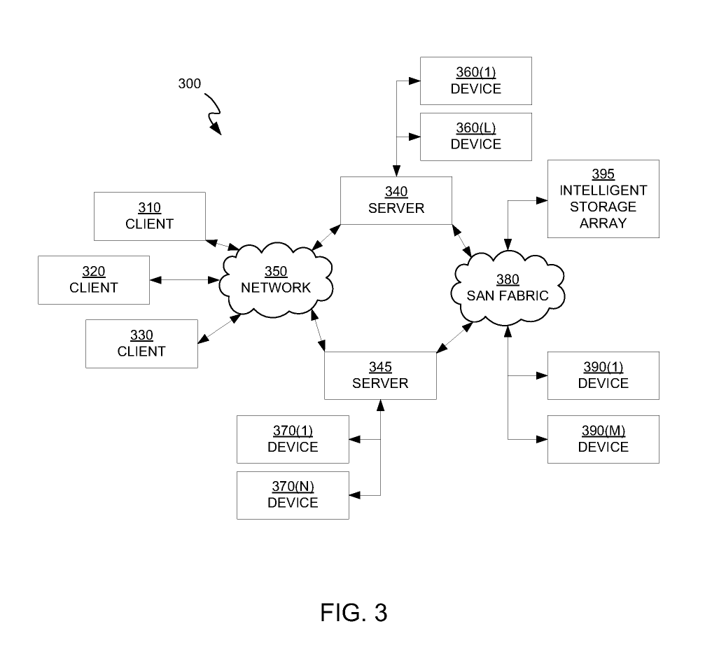

FIG. 3 is a block diagram of an example of a network architecture 300 in which client systems 310, 320, and 330 and servers 340 and 345 may be coupled to a network 350. Client systems 310, 320, and 330 generally represent any type or form of computing device or system, such as the computing system 100 of FIG. 1 or the client device 200 of FIG. 2.

Similarly, servers 340 and 345 generally represent computing devices or systems, such as application servers, configured to provide various services and/or run certain software applications. Network 350 generally represents any telecommunication or computer network including, for example, an intranet, a wide area network (WAN), a local area network (LAN), a personal area network (PAN), or the Internet.

With reference to computing system 100 of FIG. 1, a communication interface, such as communication interface 125, may be used to provide connectivity between each client system 310, 320, and 330 and network 350. Client systems 310, 320, and 330 may be able to access information on server 340 or 345 using, for example, a Web browser or other client software. Such software may allow client systems 310, 320, and 330 to access data hosted by server 340 or server 345. Although FIG. 3 depicts the use of a network (such as the Internet) for exchanging data, the embodiments described herein are not limited to the Internet or any particular network-based environment.

In one embodiment, all or a portion of one or more of the example embodiments disclosed herein are encoded as a computer program and loaded onto and executed by server 340 or server 345, or any combination thereof. All or a portion of one or more of the example embodiments disclosed herein may also be encoded as a computer program, stored in server 340, run by server 345, and distributed to client systems 310, 320, and 330 over network 350.

System and Method for Computer Peripheral Access from Cloud Computing Devices

Embodiments of the present invention provide methods and systems for computer peripheral access from cloud computing devices, for example, accessing a game pad connected to a client device. However, embodiments of the present invention can be applied to any peripheral device connected to any device.

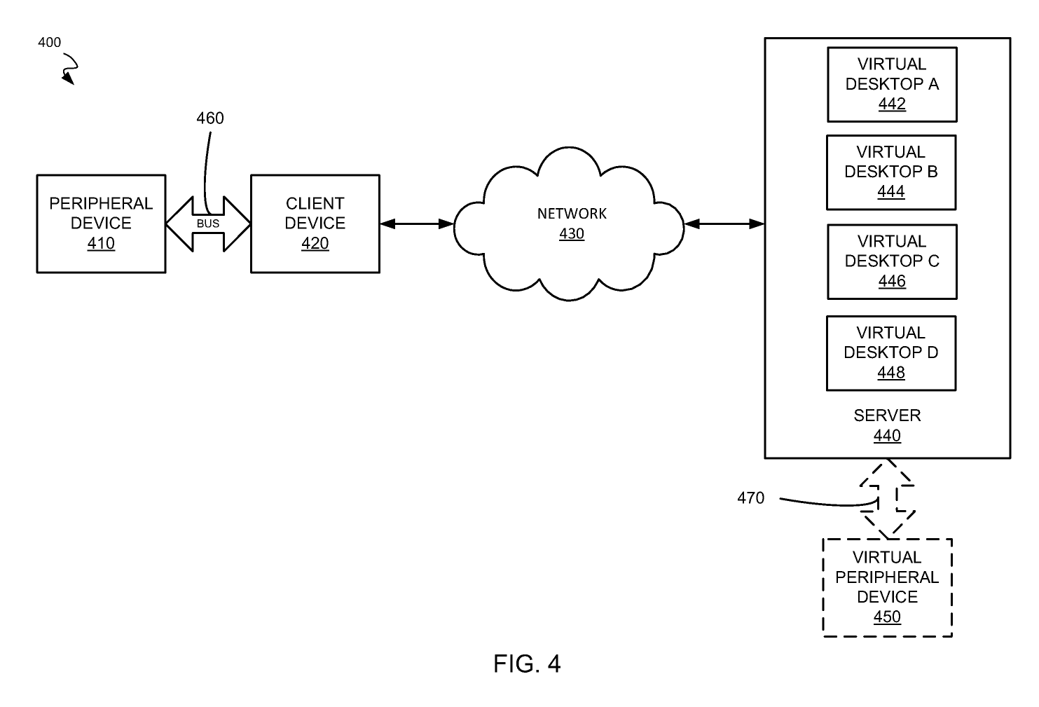

FIG. 4 is a block diagram of a computer peripheral access system 400, according to embodiments of the present invention. The computer peripheral access system 400 includes peripheral device 410, client device 420, network 430, server computer 440, and virtual peripheral device 450. Peripheral device 410 and client device 420 are coupled by a peripheral bus 460. Server computer 440 and virtual peripheral device 450 are connected by a virtual peripheral bus 470.

Peripheral device 410 may be any peripheral device connected to a host computer, e.g., client device 420. Peripheral device 410 may expand the client device's 420 capabilities without being a part of its core computer architecture. Peripheral device 410 may be, but is not limited to, an input device, output device, and/or storage device. Some examples of peripheral device 410 include, but are not limited to: keyboard, mouse, touchscreen, camera, display, printer, hard drive, flash drive, etc.

Client device 420 may be any computing device similar to the one described in FIG. 2. In some embodiments, client device 420 may be a client within a cloud-computing environment. Client device 420 may access computing resources (hardware and software) which are available on server 440 via network 430. In some embodiments, client device 420 may be a mobile device such as a smartphone or tablet device. Often times, client device 420 may not include software drivers to enable proper functionality of peripheral device 410 and it may not be possible to install the software drivers on the client device due to, for example, operating system restrictions. There may be many reasons that client device 420 does not include software drivers. For example, mobile devices have limited amounts of memory and storage and it may not be feasible to include software drivers for a many various peripheral devices 410. Or, it may be difficult or inconvenient to access the necessary driver. However, many times a user may wish to connect a peripheral device 410 to the client device 420 for expanded functionality. In some embodiments, the peripheral device 410 may be a USB device such as a game controller, keyboard, or storage device.

In some cases, the client device 420 may include software drivers for select peripherals 410. In the case of mobile devices, the client device 420 may have software drivers installed for peripherals 410 that are typically used with a mobile device, such as, but not limited to, SD card, external speakers, etc. However, the client device 420 may not include software drivers for peripherals 410 that are typically used with client devices 420 other than mobile devices, such as, but not limited to gamepads and keyboards.

A system and method describing use of a peripheral device 410 with a client device 420 that does not have software drivers for the peripheral device 410 is described below.

Peripheral bus 460 may be any subsystem operable for transferring data between the peripheral device 410 and client device 420. In some embodiments, peripheral bus 460 may be a universal serial bus (USB), controller area network bus (CANbus), eSATA bus, FireWire bus, ExpressCard bus, etc. It should be appreciated that peripheral bus 460 may be a wired and/or wireless communication channel. For example, peripheral bus 460 may provide connectivity between peripheral bus 460 and client device 420 through IEEE 802.11 Wi-Fi communication.

Network 430 may include one or more wireless and/or wired components. In some embodiments, network 430 may include the Internet. Network 430 may be similar to network 350 of FIG. 3 and may include local area network and/or wide area network portions. In some embodiments, communication via client device 420 and server 440 over the network 430 is facilitated by use of a standardized protocol, e.g., TCP/IP.

Server 440 may be a computing device similar to server 340 of FIG. 3. Server 440 may reside within a cloud computing environment and include hardware and software computing resources made available for client device 420. Server 440 may communicate with client device 420 via a communication channel, for example, network 430. Additionally, server 440 may include one or more virtual desktops. In this particular example, server 440 includes four virtual desktops: virtual desktop A 442, virtual desktop B 444, virtual desktop C 446, and virtual desktop D 448. It can be appreciated that server 440 may include any number of virtual desktops. Each virtual desktop may be used to load balance resources of server 440. The virtual desktops 442-448 may be transparent to an end user who may only see the server 440 on the network 430. In some embodiments, each virtual desktop 442-448 may be dedicated to a specific application (e.g., email, word processing, graphics editing, gaming, etc.)

Server 440 may be virtually connected to a virtual peripheral device 450. Virtual peripheral device 450 may be a virtual instance of peripheral device 410 created and used using the systems and methods described herein. Communications between peripheral device 410 and client device 420, over peripheral bus 460, may be detected and captured. For example, if USB peripheral device 410 is connected to client device 420, data packets on the USB peripheral bus 460 may be detected and captured. In some embodiments, the raw data packets from the peripheral device 410 may be captured prior to client device 420 receiving and interpreting the data packets. In some embodiments, the data packets may be detected using a snooping mechanism on the peripheral bus 460.

In some embodiments, the client device 420 may not include any device drivers for peripheral device 410. The captured data packets from peripheral bus 460 may be transferred over network 430 to server 440. In some embodiments, server 440 may include device drivers for the peripheral device 410. If server 440 does not include device drivers for the peripheral device 410, server 440 may obtain and install the required device drivers via a communication channel, e.g. via the Internet.

Server 440 may load and enable the specific device driver for the peripheral device 410. In some embodiments, the server 440 may analyze the received raw data packets to determine the type of peripheral device 410 connected to client device 420 and to ultimately determine the specific device driver required for proper operation of peripheral device 410. Upon loading and/or enabling the device driver for peripheral device 410, server 440 may create a virtual instance (virtual peripheral device 450) of the peripheral device 410. In some embodiments, the raw data packets on peripheral bus 460 may continue to be snooped by the snooping mechanism and the raw data packets may continually be transferred to server 440. As such, any input or usage of peripheral device 410 may be emulated on virtual peripheral device 450 connected to server 440 via virtual peripheral bus 470 as if peripheral device 410 itself is connected to server 440.

In some embodiments, the captured raw data packets on peripheral bus 460 may be compressed and/or encrypted prior to being transferred to server 440 over network 430. The compressed and/or encrypted raw data packets may then be decompressed and/or decrypted at server 440. The compression and encryption of the raw data packets may result in bandwidth savings on network and increased security in the data transmission. Upon decompression and/or decryption, the raw data packets may be reconstructed bit-for-bit.

As a result, peripheral device 410 may be coupled with server 440 and communicate with server 440 as virtual peripheral device 450. Accordingly, whether or not client device 420 may be capable of enabling proper functionality of peripheral device 410 with client device 420 alone, peripheral device 410 may be operable to communicate with server 440 and therefore affect the execution of software or hardware on the server 440, which may in turn affect the execution of software or hardware on client device 420.

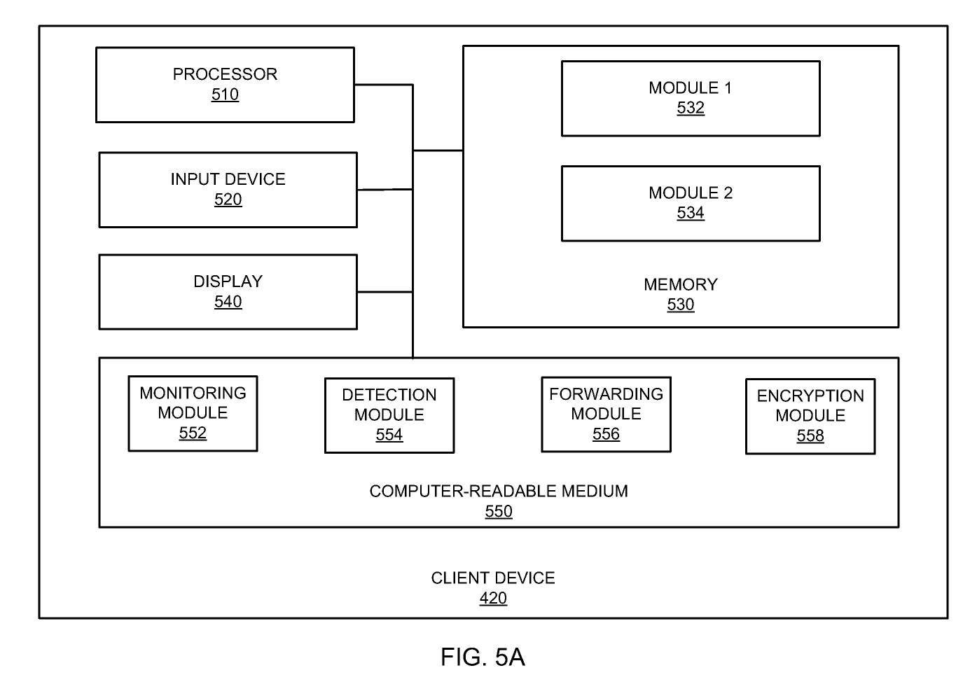

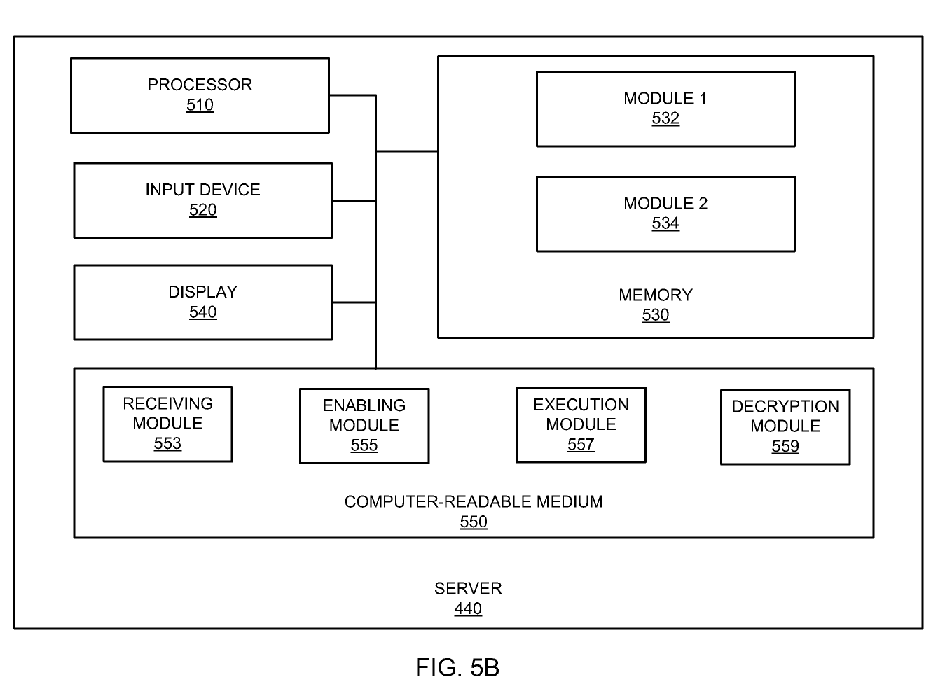

FIG. 5A is a block diagram of a client device 420, according to embodiments of the present invention. Client device 420 includes a processor 510, input device 520, memory 530, display 540, and computer-readable medium 550.

Processor 510 may be any general-purpose processor operable to carry out instructions on the client device 420. The processor 510 is coupled to other units of the client device 420 including input device 520, memory 530, display 540, and computer-readable medium 550.

Input device 520 may be any device that accepts input from a user. Examples may include a keyboard, keypad, or mouse. In some embodiments, a multi-touch pad may be an input device.

Memory 530 may be any magnetic, electronic, or optical memory. Memory 260 includes two memory modules, module 1 532 and module 2 534. It can be appreciated that memory 530 may include any number of memory modules. An example of memory 530 may be dynamic random access memory (DRAM).

Display 540 may be any device that displays information to a user. Examples may include an LCD screen, CRT monitor, or seven-segment display.

Computer-readable medium 550 may be any magnetic, electronic, optical, or other computer-readable storage medium. Computer-readable storage medium 550 includes monitoring module 552, detection module 554, forwarding module 556, and encryption module 558. Computer-readable storage medium 550 may comprise any combination of volatile and/or non-volatile memory such as, for example, buffer memory, RAM, DRAM, ROM, flash, or any other suitable memory device, alone or in combination with other data storage devices.

Monitoring module 552 is configured to monitor data communicated over a bus. For example, monitoring module 552 may monitor data communicated over peripheral bus 460 (FIG. 4) between peripheral device 410 (FIG. 4) and client device 420. In some embodiments, monitoring module 552 may monitor data on the peripheral bus 460 (FIG. 4) using a snooping mechanism. The snooping mechanism may passively monitor all data communications over the peripheral bus 460 (FIG. 4).

Detection module 554 is configured to determine that the data monitored by monitoring module 552 is in fact communicated between the peripheral device 410 (FIG. 4) and the client device 420. For example, peripheral bus 410 may be shared between client device 420 and other peripheral devices (not shown) other than peripheral device 410 (FIG. 4). Detection module 554 may detect data communications over peripheral bus 460 (FIG. 4) that originate from peripheral device 410 (FIG. 4) and are destined for client device 420, or vice versa. In some embodiments, the snooping mechanism described above may also be employed by the detection module 554 for the determination. In some embodiments, detection module 554 may also determine the type of peripheral device 410 (FIG. 4) connected to the client device 420 and generate a identifier identifying the peripheral device 410 (FIG. 4).

Forwarding module 556 may be configured to send the data determined by detection module 554 in an unaltered form, along with an identifier identifying the peripheral device, to a cloud server, wherein the data is operable to be received by a device driver executing on the cloud server. The forwarding module may send the data over the network 430 (FIG. 4). It can be appreciated that no modifications may be made to the content of the data prior to sending, besides compression and/or encryption of the data that do not alter the data when it may be decompressed and/or decrypted. That is, the receiving device driver may ultimately receive a bit-for-bit representation of the determined data.

Encryption module 558 is configured to encrypt the data prior to the sending by the forwarding module 556. The data may be encrypted using any known encryption method, such as the advanced encryption standard (AES). In some embodiments, the encryption module 556 may also compress the data prior to the sending by the forwarding module 556. The compression and encryption of the raw data packets may result in bandwidth savings on network and increased security in the data transmission. Upon decompression and/or decryption, the raw data packets may be reconstructed bit-for-bit.

FIG. 5B is a block diagram of a server 440, according to embodiments of the present invention. Server 440 includes a processor 510, input device 520, memory 530, display 540, and computer-readable medium 550.

Processor 510 may be any general-purpose processor operable to carry out instructions on the server 440. The processor 510 is coupled to other units of the client device 420 including input device 520, memory 530, display 540, and computer-readable medium 550.

Input device 520 may be any device that accepts input from a user. Examples may include a keyboard, keypad, or mouse. In some embodiments, a multi-touch pad may be an input device.

Memory 530 may be any magnetic, electronic, or optical memory. Memory 260 includes two memory modules, module 1 532 and module 2 534. It can be appreciated that memory 530 may include any number of memory modules. An example of memory 530 may be dynamic random access memory (DRAM).

Display 540 may be any device that displays information to a user. Examples may include an LCD screen, CRT monitor, or seven-segment display.

Computer-readable medium 550 may be any magnetic, electronic, optical, or other computer-readable storage medium. Computer-readable storage medium 550 includes receiving module 553, enabling module 555, execution module 557, and decryption module 559. Computer-readable storage medium 550 may comprise any combination of volatile and/or non-volatile memory such as, for example, buffer memory, RAM, DRAM, ROM, flash, or any other suitable memory device, alone or in combination with other data storage devices.

Receiving module 553 is configured to receive data in an unaltered form and an identifier identifying the peripheral device 410 (FIG. 4), wherein the unaltered data is a forwarded communication between the peripheral device (FIG. 4) and the client device 420 (FIG. 4). In some embodiments, the received data is the data sent from the client device 420 (FIG. 4) as described in FIG. 5A. Receiving module 553 may receive the data over network 430 (FIG. 4).

Enabling module 555 is configured to enable a device driver based on the received identifier. As described above, the received identifier may identify the type of peripheral device 410 (FIG. 4). The identifier may include information about the peripheral device 410 (FIG. 4) such as manufacturer, platform, model, or other pertinent information required for operation of the peripheral device 410 (FIG. 4). Based on the received identifier, the enabling module 555 may enable a device driver specific to the peripheral device 410 (FIG. 4). For example, if peripheral device 410 (FIG. 4) is a gaming pad, enabling module 555 may enable a specific gaming pad device driver on server 440.

Execution module 557 is configured to execute one or more commands via the device driver, based on the received data. In some embodiments, execution module 557 may translate the received data to a format understandable by processor 510 and processor 510 may in turn execute the data. For example, if the received data is a keystroke, based on input by the user using peripheral device 410 (FIG. 4), the enabling module 555 may enable a device driver for an input device and execution module 557 may execute the keystroke on server 440, as intended by the user.

Decryption module 559 is configured to decrypt the encrypted data, by encryption module 558 (FIG. 5A) prior to the receiving by the receiving module. The data may be decrypted using any known decryption method, such as the advanced encryption standard (AES). In some embodiments, the decryption module 559 may also decompress the data prior to the receiving by the receiving module 553.

In some embodiments, a forwarding module may be configured to send responsive data back to the client device. The responsive data may be in response to the commands executed by execution module 557. The client device may then forward the responsive data to the peripheral device. An example of responsive data may include, but is not limited to, an acknowledgment signal or an updated cursor position.

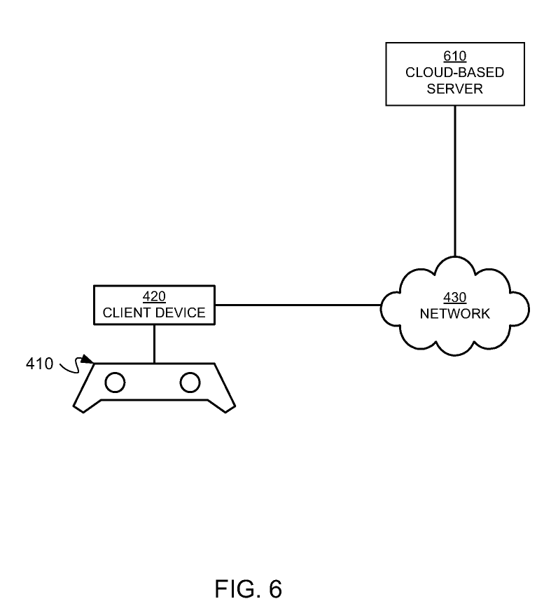

FIG. 6 is a block diagram of a peripheral device 410 communicatively coupled with a client device 420 and also a cloud-based server 610, according to embodiments of the present invention. In some embodiments, cloud-based server 610 may be similar to server 440 of FIG. 4. In some embodiments, peripheral device 410 may be a gaming input device, e.g., a joystick, steering wheel, gamepad, etc.

The peripheral device 410 may be communicatively coupled with the cloud-based server 440 through a network 430, for example, through wired or wireless interfaces. In some embodiments, the network 430 may be wide area network (WAN) or a local area network (LAN).

The cloud-based server 610 may be part of a cloud-based computing system. Cloud computing is the use of computing resources (hardware and software) that are delivered as a service over a network (typically the Internet). Therefore, the cloud-based server 610 may be remotely located from the peripheral device 410. For example, the cloud-based server 610 may be located in a separate building or city as the peripheral device 410.

In some cases, at least some of the functionality of peripheral device 410 may not be compatible with client device 420. For example, the peripheral device 410 may require use of certain device drivers that the client device 420 does not or cannot support. Alternatively, the client device 420 may not support the use of peripheral device 410 because peripheral device 410 requires heavier processing power than the client device 420 may be able to provide. Or, the peripheral device 410 may not be supported by client device 420 because the client device 410 is not compatible with the client device 420 for various reasons, e.g., the peripheral device 420 may be designed for a different platform or operating system than the one running on client device 420, thereby not allowing communication between the peripheral device 410 and client device 420.

Importantly, the cloud-based server 610 may be operable to interpret and execute commands sent by peripheral device 410. For example, the cloud-based server 610 may provide a compatible platform or operating system, may provide the necessary processing power, or may be able to communicate with the client device 420 to execute the peripheral device 410 commands. Accordingly, the device drivers for peripheral device 420 may already exist on cloud-based server 610 or may be downloaded from the Internet, installed on the cloud-based server 610, and enabled on the cloud-based server 610. For example, the cloud-based server 980 may download, install, and enable device drivers for peripheral device 410 such that peripheral device 410 may be used to play a game on client device 420 (where, in some embodiments, cloud-based server 610 also provides the game and gaming resources to client device 420).

Further, the client device 420 may receive data from the cloud-based server 610 related to or representing the game. For example, the cloud-based server 610 may send video, audio, and/or other data related to the gaming content through the network 430 to the client device 420. The other data may include, for example, instructions to activate a force feedback vibration component in the peripheral device 410.

In one example, the cloud-based server 610 may execute a software application requiring graphics and audio processing. The cloud-based server 610 may then transmit the graphics and audio to the client device 420 for display and playback. Accordingly, the client device 420 may provide the gaming content to a user of the client device 420 with the aid of the cloud-based server 610 that the gaming console may not have otherwise been able to provide. Even if the client device 420 may have been able to provide the gaming content, it may be able to do so at a lower quality or with limitations, but the cloud-based server 610 may be capable of providing higher quality and limitation-free gaming content generation to the client device 420.

The video, audio, and/or other data transmitted from the cloud-based server 610 may or may not be compressed before sending, and decompressed and/or decoded when received by the client device 420. For example, see copending U.S. patent application Ser. No. 13/727,357, “VIRTUALIZED GRAPHICS PROCESSING FOR REMOTE DISPLAY,” filed Dec. 26, 2012, which is incorporated herein by reference for all purposes. For example, the cloud-based server 610 may compress the data into H.264 format for transmittal to the client device 420. Once the client device 420 receives the data to be displayed, it may decompress and display the video, audio, and/or other data.

The client device 420 may be operable to send user inputs to the cloud-based server 610 via peripheral device 410. For example, the client device 420 may send data representing user interaction with the physical controls, touchscreen, internal/external motion tracking components, and so on of peripheral device 410, to the cloud-based server 610. In this way, a user may control software applications or content that is being executed on the cloud-based server 610. The client device 420 may send user inputs through the network 430.

Because the cloud-based server 610 may be remotely communicatively coupled with the client device 420, the client device 420 may be able to send/receive data from the cloud-based server 610 while at different locations. For example, the client device 420 may be able to send/receive data from the cloud-based server 610 while at different homes, outdoors, or even while located in different countries. Accordingly, a user of the client device 420 may be free to travel between different locations and continue to benefit from the services of the cloud-based server 610.

The various embodiments discussed with respect to other figures may be used with the cloud-based server 610. For example, there may be more than one client device.

It can be appreciated that the cloud-based server 610 may provide applications to client device 420 other than gaming. For example, cloud-based server 610 may provide professional applications to client device 420 such as, but not limited to, visual computing applications, computer aided design applications, imaging applications, etc. The use of these professional applications in a cloud-based environment may share the same benefits as those described with respect to gaming applications above. Additionally, an employer providing these professional applications may realize cost savings by not requiring to purchase expensive workstation computers with the processing power required to run powerful professional applications. Instead, employees may simply use a lower cost client device 420 to access the professional applications residing on the cloud-based server 610. Further, the client device 420 may be any platform, e.g. Mac OS, Linux, Windows, etc., allowing employees to use the platform they are the most comfortable with.

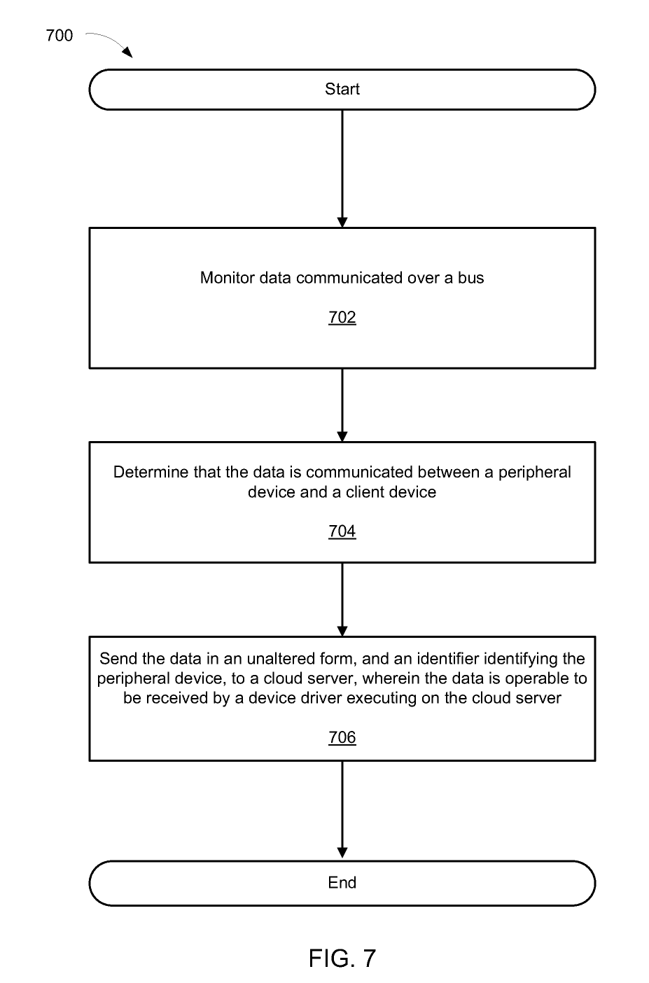

FIG. 7 depicts a flowchart 700 of an exemplary computer-implemented process sending unaltered data between a client device and peripheral device to a cloud-based server, according to an embodiment of the present invention. While the various steps in this flowchart are presented and described sequentially, one of ordinary skill will appreciate that some or all of the steps can be executed in different orders and some or all of the steps can be executed in parallel. Further, in one or more embodiments of the invention, one or more of the steps described below can be omitted, repeated, and/or performed in a different order. Accordingly, the specific arrangement of steps shown in FIG. 7 should not be construed as limiting the scope of the invention. Rather, it will be apparent to persons skilled in the relevant art(s) from the teachings provided herein that other functional flows are within the scope and spirit of the present invention. Flowchart 700 may be described with continued reference to exemplary embodiments described above, though the method is not limited to those embodiments.

In block 702, data communicated over a bus is monitored. In some embodiments, the bus may be a peripheral bus between a client device and a peripheral device. The bus may conform to a standard, such as USB or FireWire. The data may be monitored by employing a snooping mechanism on the bus. The snooping mechanism may not alter any data on the bus, but simply view all data that is communicated over the bus. For example, in FIG. 4, the data communicated on the peripheral bus, between the peripheral device and client device, is monitored.

In block 704, a determination is made whether the data is communicated between a peripheral device and a client device. In some embodiments, the determination may be made based on the monitoring of data using the snooping mechanism. The peripheral bus may experience data communication from devices other than the peripheral device and client device. For example, in FIG. 4, a determination is made whether the data communicated on the peripheral bus is communicated between the peripheral device and the client device.

In block 706, the data is sent in an unaltered form, along with an identifier identifying the peripheral device, to a cloud server. The data is operable to be received by a device driver executing on the cloud server. The identifier may be generated based on the determination in block 704. The identifier may include information such as manufacturer, type of device, platform, etc. The data may be sent to the cloud server in an unaltered form, that is, in its raw bit format. For example, in FIG. 3, the unaltered data and an identifier are sent from the client device to the server over the network. In some embodiments, the data may be encrypted prior to being sent to the server.

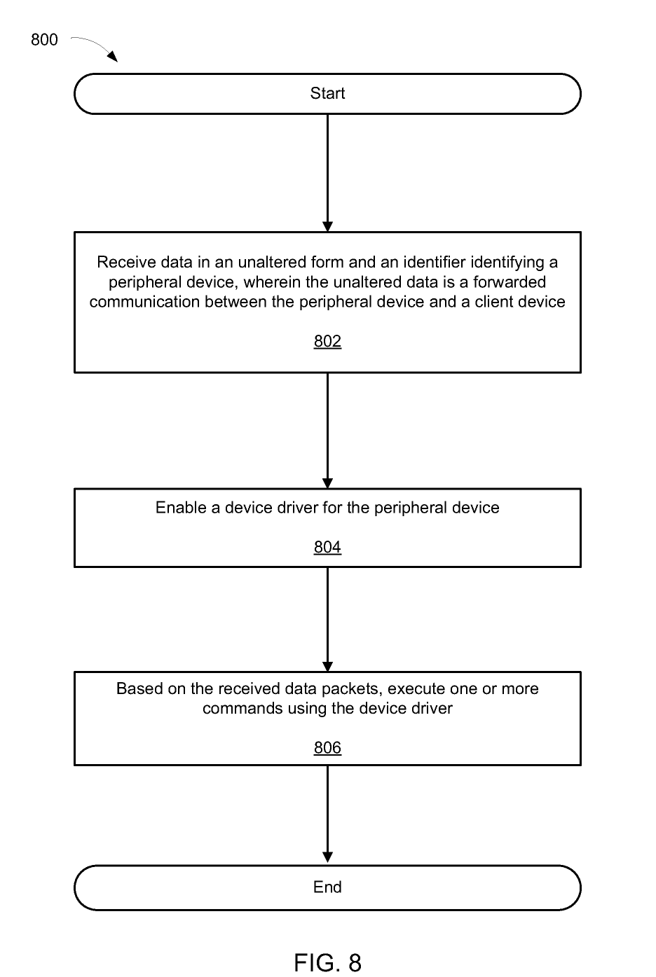

FIG. 8 depicts a flowchart 800 of an exemplary computer-implemented process of sending unaltered data between a client device and peripheral device to a cloud-based server, according to an embodiment of the present invention. While the various steps in this flowchart are presented and described sequentially, one of ordinary skill will appreciate that some or all of the steps can be executed in different orders and some or all of the steps can be executed in parallel. Further, in one or more embodiments of the invention, one or more of the steps described below can be omitted, repeated, and/or performed in a different order. Accordingly, the specific arrangement of steps shown in FIG. 8 should not be construed as limiting the scope of the invention. Rather, it will be apparent to persons skilled in the relevant art(s) from the teachings provided herein that other functional flows are within the scope and spirit of the present invention. Flowchart 800 may be described with continued reference to exemplary embodiments described above, though the method is not limited to those embodiments.

In block 802, data is received in an unaltered form along with an identifier identifying a peripheral device. The unaltered data is a forwarded communication between the peripheral device and the client device. In some embodiments, the data is decrypted upon being received. For example, in FIG. 4, the unaltered data and identifier sent by the client device, via the network, is received by the server.

In block 804, a device driver for the peripheral device is enabled. The device driver may be enabled based on the received identifier and unaltered data. For example, in FIG. 4, a device driver is enabled on the server based on the received identifier and unaltered data. If the identifier indicates that the input device is a peripheral device, the device driver for that specific device driver may be enabled.

In block 806, based on the received data, one or more commands are executed using the device driver. The commands may be executed using an execution module on the server device. For example, in FIG. 4, the server executes commands based on the received data.

In some embodiments, audio and video data associated with the executed commands are sent to the client device. For example, if the received data were data packets for a movie, the associated audio and video reconstructed from the data packets may be sent to the client device. The client device may display and play the video/audio through local resources such as a display screen and speakers.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. An apparatus comprising:
a monitoring module operable to monitor data communicated over a bus;
a detection module operable to determine that the data is communicated between a peripheral device and a client device; and
a forwarding module operable to send the data in an unaltered form, and an identifier identifying the peripheral device, to a cloud server, wherein the data is operable to be received by a device driver executing on the cloud server, and wherein further an instruction is executed on the cloud server based on the data received by the device driver.

2. The apparatus of claim 1, further comprising an encryption module operable to encrypt the data prior to the sending by the forwarding module.

3. The apparatus of claim 1, wherein the peripheral device is coupled with the cloud server through a network.

4. The apparatus of claim 1, wherein the bus is a universal serial bus (USB).

5. The apparatus of claim 1, further comprising a receiving module operable to receive responsive data from the cloud server, the responsive data being in response to the executed instruction on the cloud server, wherein the forwarding module is further operable to forward the responsive data to the peripheral device.

6. A method comprising:
monitoring data communicated over a bus;
determining that the data is communicated between a peripheral device and a client device; and
sending the data in an unaltered form, and an identifier identifying the peripheral device, to a cloud server, wherein the data is operable to be received by a device driver executing on the cloud server, and wherein further an instruction is executed on the cloud server based on the data received by the device driver.

7. The method of claim 6, further comprising encrypting the data prior to the sending.

8. The method of claim 6, wherein the peripheral device is coupled with the cloud server through a network.

9. The method of claim 6, wherein the bus is a universal serial bus (USB).

10. The method of claim 6, further comprising:
receiving responsive data from the cloud server, the responsive data being in response to the executed instruction on the cloud server; and
forwarding the responsive data to the peripheral device.

11. An apparatus comprising:
a receiving module operable to receive peripheral device data in an unaltered form and an identifier identifying a peripheral device, wherein the unaltered peripheral device data is a forwarded communication between the peripheral device and a client device;
an enabling module operable to enable a device driver based on the received identifier; and
an execution module operable to execute one or more commands via the device driver, based on the received peripheral device data.

12. The apparatus of claim 11, further comprising a decryption module operable to decrypt the peripheral device data prior to the receiving by the receiving module.

13. The apparatus of claim 11, further comprising a forwarding module operable to send audio and video data associated with the executed commands to the client device.

14. The apparatus of claim 11, further comprising a forwarding module operable to forward responsive data to the client device, wherein the responsive data is in response to the executed commands.

15. The apparatus of claim 11, wherein the peripheral device is coupled with the cloud server through a network.

16. A method comprising:
receiving peripheral device data in an unaltered form and an identifier identifying a peripheral device, wherein the unaltered peripheral device data is a forwarded communication between the peripheral device and a client device;
enabling a device driver based on the received identifier; and
executing one or more commands via the device driver, based on the received peripheral device data.

17. The method of claim 16, further comprising decrypting the peripheral device data prior to the receiving.

18. The method of claim 16, further comprising sending audio and video data associated with the executed commands to the client device.

19. The method of claim 16, forwarding responsive data to the client device, wherein the responsive data is in response to the executed commands

20. The method of claim 16, wherein the peripheral device is coupled with the cloud server through a network.
